(19) United States
(12) Patent Application Publication
(10) Pub. No.: US 2010/0054702 A1
(43) Pub. Date: Mar. 4, 2010

(54) Information processing device, information processing method, and program

(75) Inventors: Yoshiyuki Kobayashi, Kanagawa (JP); Takanori Nishimura, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/383,835

(22) Filed: Mar. 26, 2009

(30) Foreign Application Priority Data
Sep. 3, 2008 (JP) P2008-225948

(51) Int. Cl. H04N 5/91

(52) U.S. Cl. 386/95; 386/E05.001

(57) ABSTRACT

An information processing device performing a process of correcting a difference in time information between section boundaries of contents data of recording contents and section boundaries of independently acquired metadata of the recording contents is disclosed, which includes: difference calculating means for calculating a time difference candidate, which is a candidate for time correction, as a correction time for matching a predetermined section boundary of the metadata with that of the contents data; evaluation value calculating means for calculating an evaluation value indicating a degree of match of the section boundaries of the contents data and the metadata; and correction means for correcting the difference in time information using the time difference candidate having a highest evaluation value among the evaluation values calculated for the time difference candidates of all combinations of the section boundaries of the metadata and the contents data, as the correction time of the time information.

The present application contains subject matter related to that disclosed in Japanese Patent Applications JP 2007-227351 and JP 2008-225948 filed in the Japan Patent Office on Sep. 3, 2007 and Sep. 3, 2008, respectively, the entire contents of which are hereby incorporated by reference; and the present application claims priority from Japanese Patent Application No. JP 2008-225948 filed in the Japanese Patent Office on Sep. 3, 2008.

### BACKGROUND OF THE INVENTION

1. Field of the Invention

The present invention relates to an information processing device, an information processing method, and a program, and more particularly, to an information processing device, an information processing method, and a program capable of correcting a difference between time information of recording contents and time information of metadata.

2. Description of the Related Art

The recording of programs like television broadcast could be performed by various apparatuses such as a personal computer or a mobile phone having a television tuner, in addition to a recording apparatus (recording and reproducing apparatus) recording the programs on a recording medium such as a video tape, a DVD (Digital Versatile Disc), and a hard disc, regardless of a stationary type or a portable type.

It was general in the past that the recording apparatus receives and records only programs (television moving images) acquired from electric waves of television broadcast. However, some recording apparatuses recently have functions of receiving EPG (Electronic Program Guide) data included in the electric waves of television broadcast and displaying an electronic program list to allow a user to simply reserve the programs or automatically recording programs suitable for a user's taste.

In recent years, some recording apparatuses have a function of accessing the Internet (for example, see JP-A-2004-23345). In the recording apparatuses having the function of accessing the Internet, data other than the electric waves of television broadcast, for example, section information where a program is divided into sections corresponding to subjects in the program or information on articles, stores, or characters introduced in the sections, could be acquired as metadata from a predetermined metadata providing server and be displayed at the same time as reproducing recorded programs or be displayed on a picture for displaying a program list of the recorded programs. Accordingly, in reproducing the recorded programs, a system different from the past system simply reproducing the recorded program was embodied.

When acquiring metadata of the recorded program (hereinafter, referred to as “recording contents”) from a metadata providing server, the recording apparatus transmits time information for specifying the recording contents, such as a recording start time and a recording end time (including date) of the recording contents, to the metadata providing server and the metadata providing server returns the metadata on the program having been broadcasted at the transmitted date and time.

### SUMMARY OF THE INVENTION

However, when the time information transmitted from the recording apparatus is based on the time (hereinafter, properly referred to as “time of the recording apparatus”) set by a clock function of the recording apparatus and the time is shifted from a true time (hereinafter, referred to as “true time”), the details recorded as the recording contents may not be matched with the details of the metadata acquired from the metadata providing server as the metadata corresponding to the recording contents. A problem when the time information of the metadata is not matched with the recording contents will be described now with reference to FIGS. 1 and 2.

FIG. 1 is a diagram illustrating an example where the time of the recording apparatus is accurately set and recording contents are recorded at 9:00 in the time of the recording apparatus.

When the time of the recording apparatus is accurate, the details of the recording contents recorded by the recording apparatus are recorded from the true time 9:00. Since the recording apparatus transmits the time information having 9:00 as the recording start time of the recording contents to the metadata providing server, the metadata providing server also returns the metadata from the true time 9:00. Accordingly, the details of the recording contents are matched with the details of the metadata.

On the contrary, FIG. 2 is a diagram illustrating an example where the time of the recording apparatus is set to lead by 2 minutes from the true time and the recording contents are recorded from 9:00 in the time of the recording apparatus.

When the time of the recording apparatus leads by 2 minutes from the true time, the recording apparatus starts the recording at the true time 8:58 leading by 2 minutes from the true time 9:00 and being recognized as 9:00. Accordingly, the recording apparatus records a CM (commercial message) from the true time from 8:58 to 9:00 between the time from 9:00 to 9:02 in the time of the recording apparatus, which is indicated by hatched lines in FIG. 2. Thereafter, since the recording apparatus transmits the time information including 9:00 as the recording start time of the recording contents to the metadata providing server, the metadata providing server returns the metadata from the true time 9:00, similarly to the example shown in FIG. 1. As a result, the metadata represents that main section 1 of the recording contents is broadcasted from 9:00, but the CM is actually broadcasted. That is, there is a phenomenon that the details of the recording contents are not matched with the details of the metadata acquired from the metadata providing server.

The time of the recording apparatus is usually set by a user of the recording apparatus. Accordingly, the precision of the set time depends on the user, but the time is hardly set accurately to the unit of seconds. Even when the user accurately sets the time, the clock function of the recording apparatus is often shifted by over 10 seconds per month. When the recording apparatus has a function of detecting a time signal of a broadcast program and automatically adjusting the time or a function of accessing the Internet as a function of adjusting the time of the recording apparatus without depending on the user, it can be considered that the time is automatically adjusted using an NTP (Network Time Protocol). However, in the type of detecting the time signal of a broadcast program, a time delay due to various processes is caused in apparatuses such as a broadcast equipment and a receiver and thus it is difficult to accurately adjust the time using the time signal. In the type using the NTP, the recording apparatus not accessing the Internet cannot adjust the time. It is not guaranteed that the user necessarily turns on the automatic time adjusting function.

Regarding the time of the metadata, when the metadata is acquired from a metadata provider, it is considered that the metadata provider prepares the metadata on the basis of the accurate time. When the user prepares the metadata, it is not guaranteed that the time of the metadata is accurate, similarly to the time of the recording apparatus, but the start time of a program and the like can be recognized in preparing the metadata. Accordingly, even when the time of the recording apparatus is shifted, it is possible to correct the time.

As described above, it cannot be expected that the time information of the recording apparatus is always matched with the time information of the metadata, and the phenomenon shown in FIG. 2 can easily occur. When the time information of the recording apparatus is not matched with the time information of the metadata, it is not possible to accurately perform, for example, the reproduction of the recording contents from the position (predetermined time) represented by the metadata or the display (interaction) of the metadata matched with the reproduction position of the recording contents.

Accordingly, it is desirable to correct a difference between the time information of the recording contents and the time information of the metadata.

According to a first embodiment of the invention, there is provided an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device including: difference calculating means for calculating a time difference candidate, which is a candidate for time correction, as a correction time for matching a predetermined section boundary of the metadata with a predetermined section boundary of the contents data; evaluation value calculating means for calculating an evaluation value indicating a degree of match of the section boundaries of the contents data and the metadata when the time information of all the section boundaries of the metadata is shifted by the time difference candidate; and correction means for correcting the difference in time information using the time difference candidate, which has a highest evaluation value among the evaluation values calculated for the time difference candidates of all combinations in which the section boundaries of the metadata and the contents data are matched with each other, as the correction time of the time information.

The correction means may determine whether the time difference candidate having the highest evaluation value of the calculated evaluation values is equal to or greater than a predetermined expected evaluation value and may correct the difference in time information when determining that the time difference candidate is equal to or greater than the expected evaluation value.

The evaluation value calculating means may calculate the evaluation value on the basis of an absolute difference in time information between the section boundaries of the metadata and the contents data when the time information of all the section boundaries of the metadata is shifted by the time difference candidate.

The correction means may correct the difference in time information using the time difference candidate, which has the highest evaluation value among the evaluation values calculated for the time difference candidates of all combinations in which the section boundaries of the metadata and the contents data are matched with each other, as the correction time of the time information, one or both of a start time and an end time of the CM section.

The information processing device may further include recording contents analyzing means for extracting an image feature quantity of the contents data and dividing the contents data into a plurality of sections on the basis of the extracted image feature quantity.

The information processing device may further include metadata acquiring means for acquiring the metadata of the recording contents from a different server.

The correction means may correct the difference in time information of uncorrectable recording contents using the correction time of the time information of the recording contents recorded at a time close to the uncorrectable recording contents when the uncorrectable recording contents exist which are recording contents whose difference in time information cannot be corrected because the section boundaries cannot be detected.

According to a first embodiment of the invention, there is provided an information processing method of an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing method including the steps of: calculating a time difference candidate, which is a candidate for time correction, as a correction time for matching a predetermined section boundary of the metadata with a predetermined section boundary of the contents data; calculating an evaluation value indicating a degree of match of the section boundaries of the contents data and the metadata when the time information of all the section boundaries of the metadata is shifted by the time difference candidate; and correcting the difference in time information using the time difference candidate, which has a highest evaluation value among the evaluation values calculated for the time difference candidates of all combinations in which the section boundaries of the metadata and the contents data are matched with each other, as the correction time of the time information.

According to the first embodiment of the invention, there is also provided a program allowing a computer to perform a process of correcting a difference in time information between section boundaries of contents data of recording contents and section boundaries of metadata of the recording contents acquired independently of the contents data, where the section boundaries are boundaries of sections when the recording contents are divided into a plurality of sections, the process including the steps of: calculating a time difference candidate, which is a candidate for time correction, as a correction time for matching a predetermined section boundary of the metadata with a predetermined section boundary of the contents data; calculating an evaluation value indicating a degree of match of the section boundaries of the contents data and the metadata when the time information of all the section boundaries of the metadata is shifted by the time difference candidate; and correcting the difference in time information using the time difference candidate, which has a highest evaluation value among the evaluation values calculated for the time difference candidates of all combinations in which the section boundaries of the metadata and the contents data are matched with each other, as the correction time of the time information.

In the first embodiment of the invention, a time difference candidate which is a candidate for time correction is calculated as a correction time for matching a predetermined section boundary of the metadata with a predetermined section boundary of the contents data, an evaluation value indicating a degree of match of the section boundaries of the contents data and the metadata is calculated when the time information of all the section boundaries of the metadata is shifted by the time difference candidate, and the difference in time information is corrected using the time difference candidate, which has a highest evaluation value among the evaluation values calculated for the time difference candidates of all combinations in which the section boundaries of the metadata and the contents data are matched with each other, as the correction time of the time information.

According to a second embodiment of the invention, there is provided an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device including: difference calculating means for acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and correction means for correcting the difference in time information at the start point and the end point of the predetermined section of the metadata using the smaller of the first absolute difference and the second absolute difference.

The correction means may correct start points and end points of sub sections when a predetermined section of the metadata is divided into a plurality of sub sections.

According to the second embodiment of the invention, there is also provided an information processing method of an information processing device performing a process of correcting a difference in time information between section boundaries of contents data of recording contents and section boundaries of, metadata of the recording contents acquired independently of the contents data, where the section boundaries are boundaries of sections when the recording contents are divided into a plurality of sections, the information processing method including the steps of: acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and correcting the difference in time information at the start point and the end point of the predetermined section of the metadata using the smaller of the first absolute difference and the second absolute difference.

According to the second embodiment of the invention, there is provided a program allowing a computer to perform a process of correcting a difference in time information between section boundaries of contents data of recording contents and section boundaries of metadata of the recording contents acquired independently of the contents data, where the section boundaries are boundaries of sections when the recording contents are divided into a plurality of sections, the process including the steps of: acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and correcting the difference in time information at the start point and the end point of the predetermined section of the metadata using the smaller of the first absolute difference and the second absolute difference.

In the second embodiment of the invention, a start point and an end point of a predetermined section of the metadata is acquired, a first absolute difference which is an absolute value of a difference in time information between the start point and the section boundary of the contents data closest to the start point and a second absolute difference which is an absolute value of a difference in time information between the end point and the section boundary of the contents data closest to the end point are calculated, and the difference in time information at the start point and the end point of the predetermined section of the metadata is corrected using the smaller of the first absolute difference and the second absolute difference.

According to the first and second embodiments of the invention, it is possible to correct the difference between the time information of the recording contents and the time information of the metadata.

### BRIEF DESCRIPTION OF THE DRAWINGS

FIG. 1 is a diagram illustrating a problem when recording contents and metadata are not matched with each other in time information.

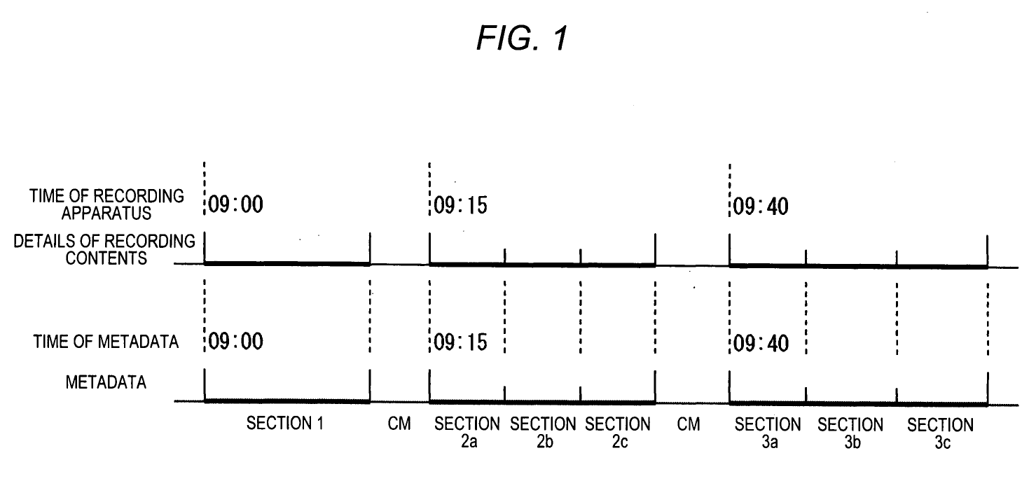

FIG. 2 is a diagram illustrating a problem when the recording contents and the metadata are not matched with each other in time information.

FIG. 3 is a block diagram illustrating a configuration of an example of an image display apparatus to which the invention is applied.

FIG. 4 is a flowchart illustrating a contents recording process.

FIG. 5 is a flowchart illustrating a contents metadata acquiring process.

FIG. 6 is a diagram illustrating a state after a matching process.

FIG. 7 is a block diagram illustrating a configuration of a contents recording unit.

FIG. 8 is a diagram illustrating initial states of contents data and contents metadata.

FIG. 9 is a diagram illustrating matching trial 1 of an evaluation value calculating process.

FIG. 10 is a diagram illustrating the calculation of an inter-CM section presence equivalent β.

FIG. 11 is a diagram illustrating the calculation of an inter-CM section presence equivalent β.

FIG. 12 is a diagram illustrating matching trial 2 of the evaluation value calculating process.

FIG. 13 is a diagram illustrating matching trial 3 of the evaluation value calculating process.

FIG. 14 is a flowchart illustrating a matching process.

FIG. 15 is a flowchart illustrating an evaluation value calculating process.

FIG. 16 is a diagram illustrating a matching process performed on unmatchable recording contents.

FIG. 17 is a flowchart illustrating the matching process performed on unmatchable recording contents.

FIG. 18 is a diagram illustrating a simple matching process.

FIG. 19 is a flowchart illustrating the simple matching process.

FIG. 20 is a block diagram illustrating a configuration of a computer to which the invention is applied.

### DESCRIPTION OF PREFERRED EMBODIMENTS

Hereinafter, embodiments of the invention will be described. The correspondence between requirements of the invention and the embodiments described or shown in the specification or the drawings is as follows. This description is intended to confirm that the embodiments supporting the invention are described or shown in the specification or the drawings. Therefore, even when any embodiment is described or shown in the specification or the drawings but is not described herein as an embodiment corresponding to a requirement of the invention, it does not mean that the embodiment does not correspond to the requirement. On the contrary, even when an embodiment is described herein to correspond to a requirement, it does not mean that the embodiment does not correspond to a requirement other than the requirement.

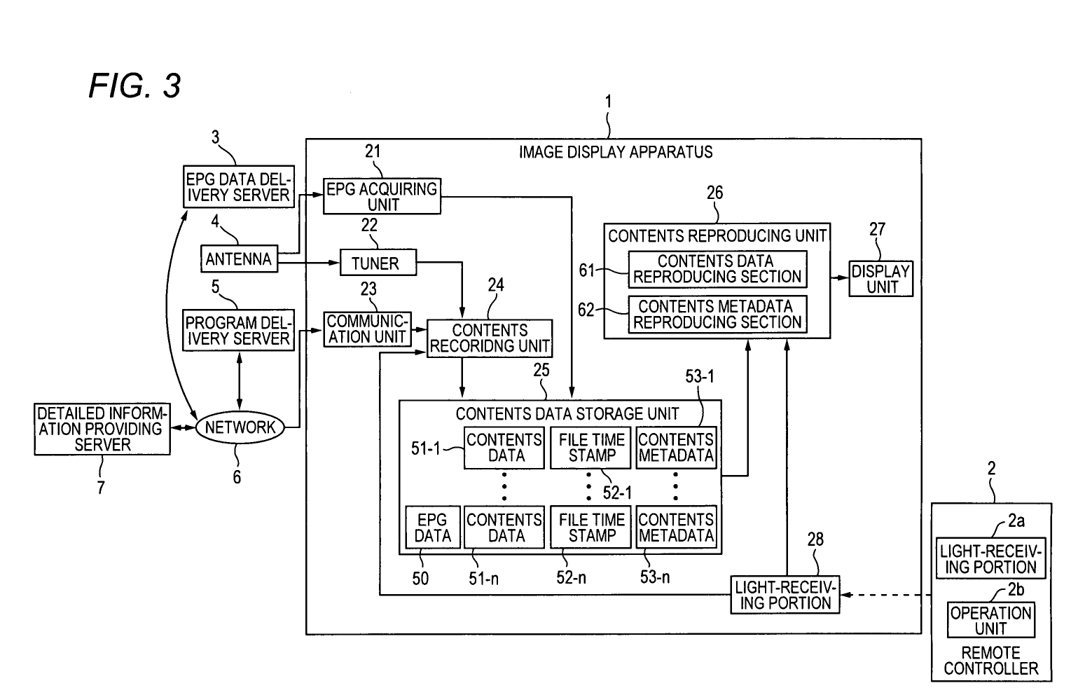

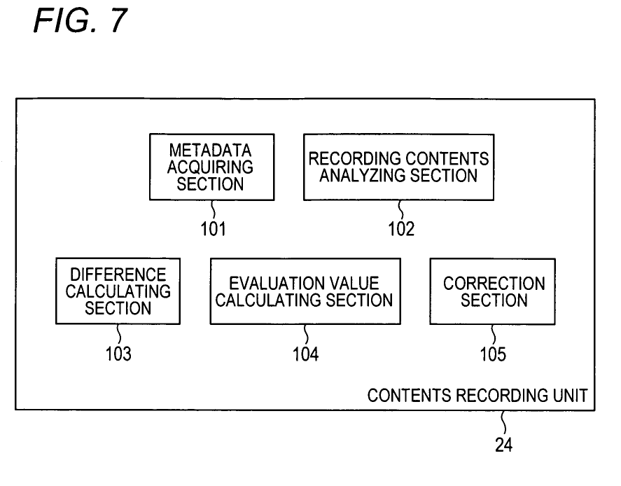

An information processing device (for example, an image display device 1 shown in FIG. 3) according to a first embodiment of the invention is an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device including: difference calculating means (for example, a difference calculating section 103 shown in FIG. 7) for calculating a time difference candidate, which is a candidate for time correction, as a correction time for matching a predetermined section boundary of the metadata with a predetermined section boundary of the contents data; evaluation value calculating means (for example, an evaluation value calculating section 104 shown in FIG. 7) for calculating an evaluation value indicating a degree of match of the section boundaries of the contents data and the metadata when the time information of all the section boundaries of the metadata is shifted by the time difference candidate; and correction means (for example, a correction section 105 shown in FIG. 7) for correcting the difference in time information using the time difference candidate, which has a highest evaluation value among the evaluation values calculated for the time difference candidates of all combinations in which the section boundaries of the metadata and the contents data are matched with each other, as the correction time of the time information.

The information processing device may further include recording contents analyzing means (for example, a recording contents analyzing section 102 shown in FIG. 7) for extracting an image feature quantity of the contents data and dividing the contents data into a plurality of sections on the basis of the extracted image feature quantity.

The information processing device may further include metadata acquiring means (for example, a metadata acquiring section 101 shown in FIG. 7) for acquiring the metadata of the recording contents from a different server.

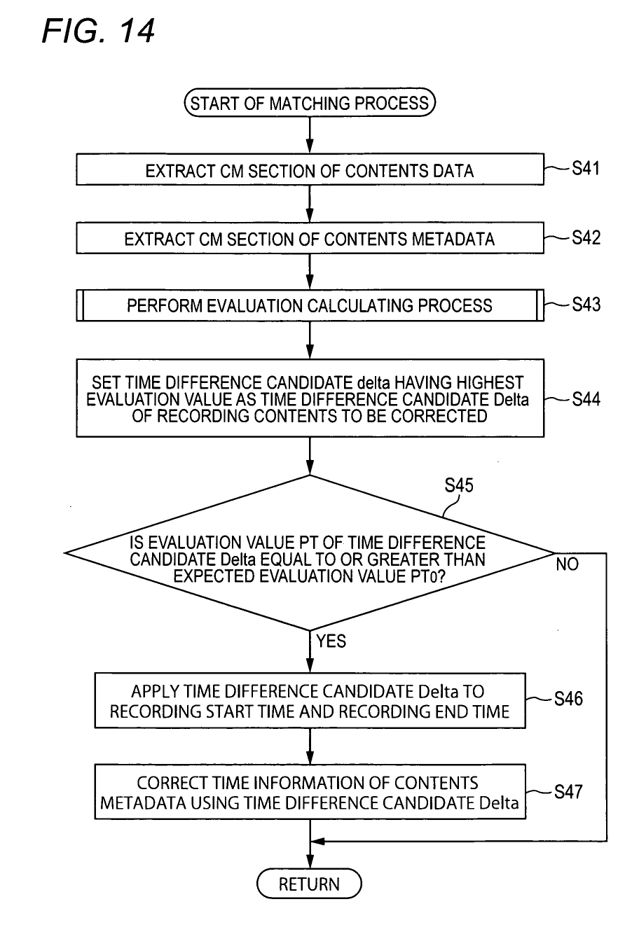

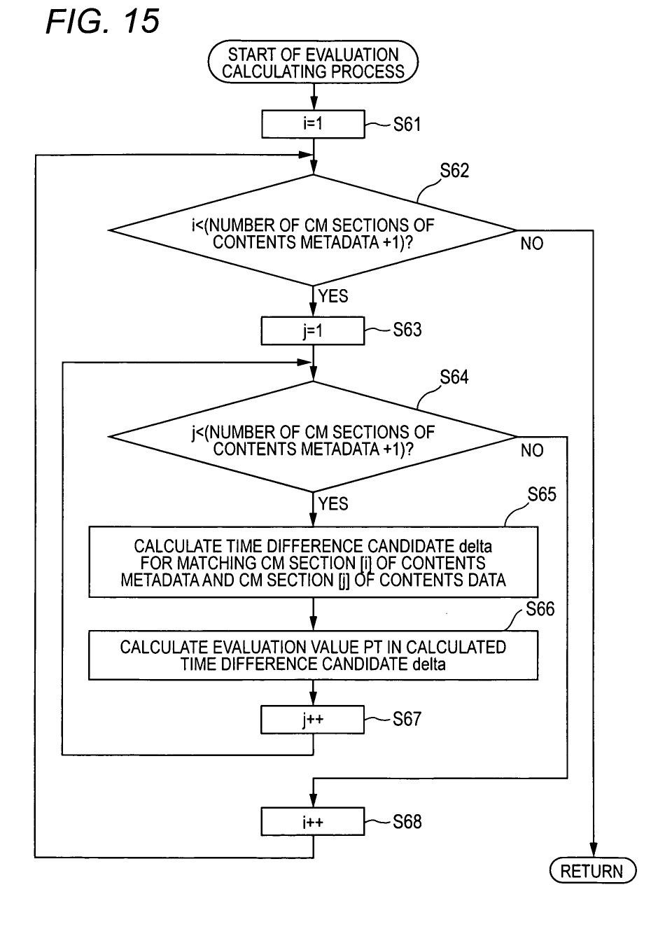

An information processing method according to the first embodiment of the invention is an information processing method of an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing method including the steps of: calculating a time difference candidate, which is a candidate for time correction, as a correction time for matching a predetermined section boundary of the metadata with a predetermined section boundary of the contents data (for example, step S65 shown in FIG. 15); calculating an evaluation value indicating a degree of match of the section boundaries of the contents data and the metadata when the time information of all the section boundaries of the metadata is shifted by the time difference candidate (for example, step S66 shown in FIG. 15); and correcting the difference in time information using the time difference candidate, which has a highest evaluation value among the evaluation values calculated for the time difference candidates of all combinations in which the section boundaries of the metadata and the contents data are matched with each other, as the correction time of the time information (for example, step S47 shown in FIG. 14).

An information processing device (for example, an image display device 1 shown in FIG. 3) according to a second embodiment of the invention is an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device including: difference calculating means (for example, a difference calculating section 103 shown in FIG. 7) for acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and correction means (for example, a correction section 105 shown in FIG. 7) for correcting the difference in time information at the start point and the end point of the predetermined section of the metadata using the smaller of the first absolute difference and the second absolute difference.

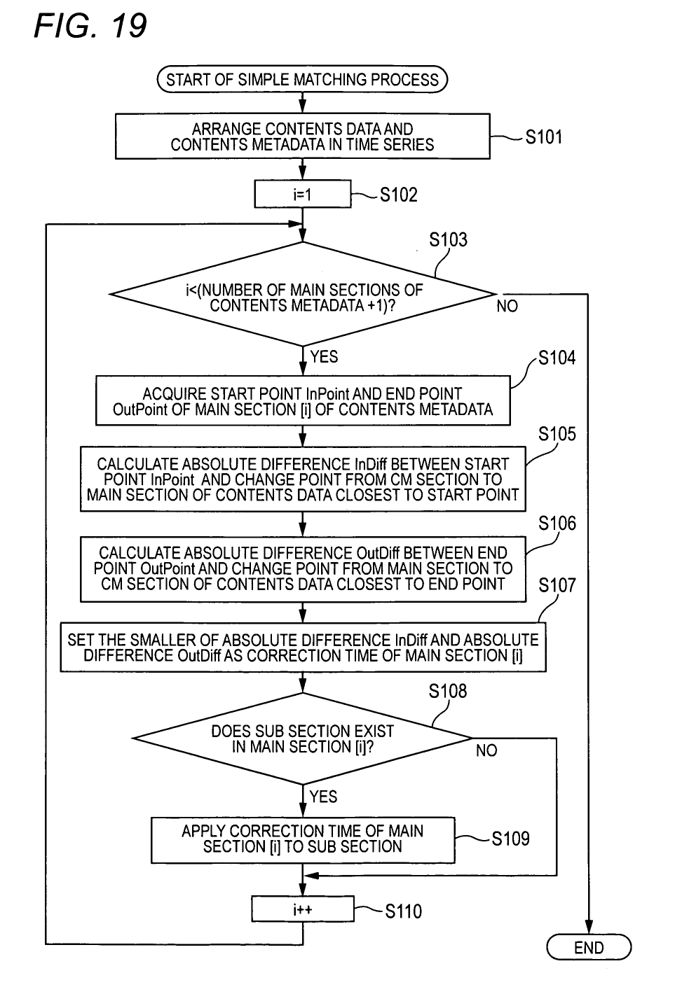

An information processing method according to the second embodiment is an information processing method of an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing method including the steps of: acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point (for example, steps S105 and S106 shown in FIG. 19); and correcting the difference in time information at the start point and the end point of the predetermined section of the metadata using the smaller of the first absolute difference and the second absolute difference (for example, step S107 shown in FIG. 19).

Hereinafter, embodiments of the invention will be described with reference to the drawings.

FIG. 3 is a diagram illustrating a configuration of an image display device (information processing device) to which an embodiment of the invention is applied.

The image display device 1 is, for example, a television receiver. The image display device 1 is operated by a remote controller 2 to receive and display contents (programs) delivered along with broadcast waves from a broadcast station not shown by the use of an antenna 4 and to record or reproduce the contents. The image display device 1 acquires and displays contents delivered from a program delivery server 5 through a network 6 such as the Internet and records or reproduces the contents.

An EPG acquiring unit 21 acquires EPG data 50 delivered along with the broadcast waves from the broadcast station not shown by the use of the antenna 4 and stores the EPG data in a contents data storage unit 25 such as an HDD (Hard Disk Drive). The EPG acquiring unit 21 controls a communication unit 23 including a modem to access an EPG data delivery server 3 via the network 6, to acquire the EPG data 50, and to store the acquired EPG data in the contents data storage unit 25.

A contents recording unit 24 is controlled by the remote controller 2 to adjust a tuner 22 to a predetermined channel, to receive contents data 51 of the contents delivered along with the broadcast waves from the broadcast station not shown through the antenna 4, and to store the received contents data in the contents data storage unit 25. The broadcast waves may be based on analog broadcast or digital broadcast. When analog broadcast signals are received, the received analog signals should be converted into digital signals so as to store the received signals in the contents data storage unit 25.

The contents recording unit 24 controls the communication unit 23 to store the contents delivered via the network 6 from the program delivery server 5 as the contents data 51 in the contents data storage unit 25.

The contents recording unit 24 stores recording date and time, broadcasting time, and a channel of the contents data 51 as a file time stamp 52 in the contents data storage unit 25 at the time of storing the contents data 51 in the contents data storage unit 25.

The contents recording unit 24 controls the communication unit 23 to acquire detailed information of the contents data 51 stored in the contents data storage unit 25 from a detailed information providing server 7 via the network 6 and to store the acquired detailed information as contents metadata 53. The contents recording unit 24 transmits the file time stamp 52 of the contents data 51 to the detailed information providing server 7 and acquires the contents metadata 53 of the contents data 51 in response thereto.

Accordingly, the EPG data 50 supplied from the EPG acquiring unit 21 and the contents data 51, the file time stamp 52, and the contents metadata 53 supplied from the contents recording unit 24 are stored in the contents data storage unit 25. The contents data 51-1 to 51-n represent the contents data 51 of different recording contents, the file time stamps 52-1 to 52-n represent the file stamps 52 of the contents data 51-1 to 51-n, and the contents metadata 53-1 to 53-n represent the contents metadata 53 of the contents data 51-1 to 51-n.

The EPG data 50 is information such as title, recording date and time, broadcast time, channel (which is a broadcast station in case of broadcast waves and a delivery source company in case of net delivery), genre, and player of a program to be broadcast or delivered now, but the contents metadata 53 is information such as title, recording date and time, broadcast time, channel, genre, and player of a program (recording contents) recorded by the contents recording unit 24 and information representing boundaries of program sections and CM (Commercial Message) sections.

The contents recording unit 24 records contents and prepares the contents data 51 and the file time stamp 52 on the basis of the time counted by a clock function built in the image display device 1. However, when the time based on the clock function is not accurate, there occurs a phenomenon that details of the contents data 51 are not matched with details of the contents metadata 53 which is metadata corresponding to the contents data. Therefore, the contents recording unit 24 performs a matching process of matching (correcting) the respective time information with each other so as to match the details of the contents data 51 with the details of the contents metadata 53.

When an instruction to reproduce predetermined contents data 51 is given from the remote controller 2 through a light-receiving portion 28, a contents data reproducing unit 61 of a contents reproducing unit 26 reads and reproduces the corresponding contents data 51 from the contents data storage unit 25 and displays the contents data on a display unit 27 including a CRT (Cathode Ray Tube) display or an LCD (Liquid Crystal Display).

A contents metadata reproducing unit 62 reads the contents metadata 53 from the contents data storage unit 25 and displays the detailed information of the recording contents stored in the contents data storage unit 25 on the display unit 27. For example, the contents metadata reproducing unit 62 displays a recording contents list picture representing a list of recording contents stored in the contents data storage unit 25 on the display unit 27.

The contents reproducing unit 26 includes a reproducing application such as a video player or browser reproducing a video to reproduce contents delivered through a network and can start the reproducing application as needed.

The light-receiving portion 28 receives infrared signals emitted from a light-emitting portion 2a with the operation of an operation unit 2b of the remote controller 2, converts the received infrared signals into operation signals, and supplies the operation signals to the contents recording unit 24 and the contents reproducing unit 26.

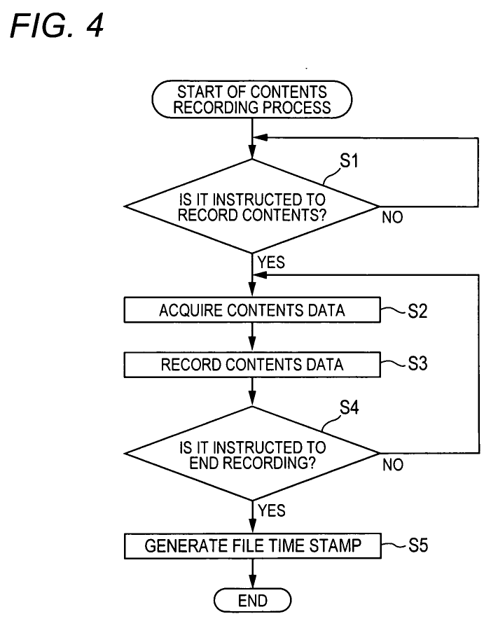

A contents recording process of the contents recording unit 24 will be described now with reference to the flowchart shown in FIG. 4.

In step S1, the contents recording unit 24 determines whether a recording instruction is given on the basis of the operation signal acquired from the light-receiving portion 28 and repeatedly performs the process until a recording instruction is given.

When determining in step S1 that a recording instruction is given, the contents recording unit 24 acquires the contents data 51 of the contents instructed to record in step S2. That is, the contents recording unit 24 controls the tuner 22 to set a channel and acquires the contents data 51 received by the antenna 4 through the set channel. The contents which can be instructed to record are not limited to the contents delivered along with the broadcast waves. For example, when it is instructed to record contents delivered through a network from the program delivery server 5, the contents recording unit 24 controls the communication unit 23 to access the program delivery server 5 through the network 6 and to acquire the contents data 51.

In step S3, the contents recording unit 24 stores the acquired contents data 51 in the contents data storage unit 25.

In step S4, the contents recording unit 24 determines whether it is instructed to end the recording. When it is determined in step S4 that it is not instructed to end the recording, the process returns to step S2 and the contents data 51 is continuously acquired and recorded. On the other hand, when it is determined in step S4 that it is instructed to end the recording, the process goes to step S5, the contents recording unit 24 generates the file time stamp 52 of the recorded contents and stores the generated file time stamp in the contents data storage unit 25, and ends the contents recording process.

When the contents recording unit 24 records the contents data 51 delivered through a network, it is determined in step S4 whether it is instructed to end the recording or the delivery of the contents is ended. When the contents data 51 is continuously delivered without any instruction of end, the process returns to step S2. On the other hand, when it is instructed to end the recording or the delivery of the contents data 51 is ended, the process goes to step S5.

In the above-mentioned processes, the contents data 51 acquired in step S2 is sequentially supplied to and stored in the contents data storage unit 25 in step S3. However, when the preparation of the contents data 51 of one file is ended, the contents data may be supplied in a bundle to the contents data storage unit 25. When the contents data 51 is supplied to the contents data storage unit 25, the contents data may be not only supplied directly but also supplied via an external memory unit such as an HDD (Hard Disk Drive) or a main memory unit such as a RAM (Random Access Memory).

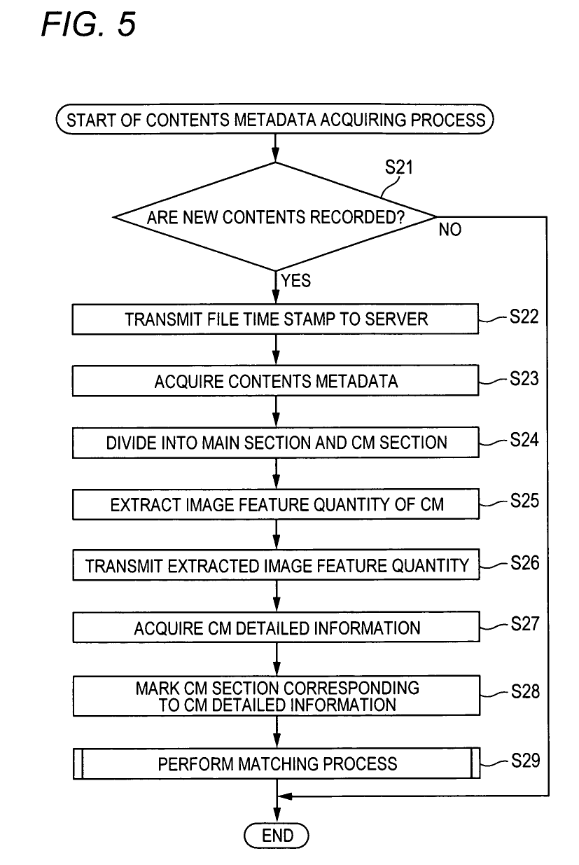

A contents metadata acquiring process of acquiring the contents metadata 53 corresponding to the recorded contents data 51 will be described now with reference to the flowchart shown in FIG. 5. This process is started at a predetermined time interval such as once per day.

In step S21, the contents recording unit 24 determines whether newly recorded contents exist in the contents data storage unit 25. When it is determined in step S21 that newly recorded contents do not exist, the contents metadata acquiring process is ended.

On the other hand, when it is determined in step S21 that newly recorded contents exist, that is, when the contents data 51 recorded after the previous contents metadata acquiring process and not having the contents metadata 53 is stored in the contents data storage unit 25, the process goes to step S22, and the contents recording unit 24 controls the communication unit 23 to transmit the file time stamp 52 of the contents data 51 (hereinafter, properly referred to as “corresponding contents data 51”) not having the contents metadata 53 yet to the detailed information providing server 7 via the network 6.

In step S23, the contents recording unit 24 receives and acquires the contents metadata 53 of the corresponding contents data 51, which is transmitted from the detailed information providing server 7 in accordance with the file time stamp 52, through the communication unit 23.

The processes of steps S24 to S28 are a contents analyzing process of allowing the contents recording unit 24 itself to analyze the corresponding contents data 51 and to divide the corresponding contents data 51 into main sections and CM sections of a program.

In step S24, the contents recording unit 24 divides the corresponding contents data 51 into the main sections and the CM sections of a program. Here, when one CM section between a main section and a next main section includes plural CMs, the contents recording unit 24 divides the CM section by the CMs. A section of one CM in the CM section including the plural CMs is referred to as a single CM section in the following description.

In step S25, the contents recording unit 24 extracts a CM image feature quantity for the CM of the respective single CM sections divided in step S24.

In step S26, the contents recording unit 24 controls the communication unit 23 to transmit the extracted CM image feature quantities to the detailed information providing server 7.

In step S27, the contents recording unit 24 controls the communication unit 23 to receive and acquire CM detailed information transmitted from the detailed information providing server 7 on the basis of the image feature quantities. The CM detailed information is information (hereinafter, properly referred to as “CM detailed information”) on the details of the CM such as article names, titles, company names, and company URLs of the CM corresponding to the CM image feature quantities transmitted from the image display device 1. When there is no CM corresponding to the CM image feature quantities transmitted from the image display device 1, information of “no corresponding CM” is returned from the detailed information providing server 7.

In step S28, the contents recording unit 24 marks a single CM section corresponding to the CM detailed information. That is, since the CM section whose CM detailed information is returned from the detailed information providing server 7 in the single CM section divided in step S24 is definitely a CM part, the contents recording unit 24 marks the main sections and the single CM sections defined as the CM part in the single CM sections of the program divided in step S24. Here, the marked single CM section is referred to as a “Defined CM section.”

Therefore, by the contents analyzing process of steps S24 to S28, the corresponding contents data 51 is divided into the main sections and the single CM sections of the program and data in which the single CM sections defined as the CM part on the basis of the CM detailed information are marked are generated.

In step S29, the contents recording unit 24 performs a matching process of matching the time information of the contents metadata 53 with the time information of the contents data 51 divided into the main sections and the single CM sections and having the Defined CM sections, and ends the process.

As described above, the image display device 1 prepares the contents data 51 and the file time stamp 52 on the basis of the time counted by the clock function built in the image display device 1 and stores the prepared data in the contents data storage unit 25, in the contents recording process shown in FIG. 4. In the contents metadata acquiring process shown in FIG. 5, the image display device 1 transmits the file time stamp 52 to the detailed information providing server 7 to acquire the contents metadata 53 and stores the acquired contents metadata in the contents data storage unit 25.

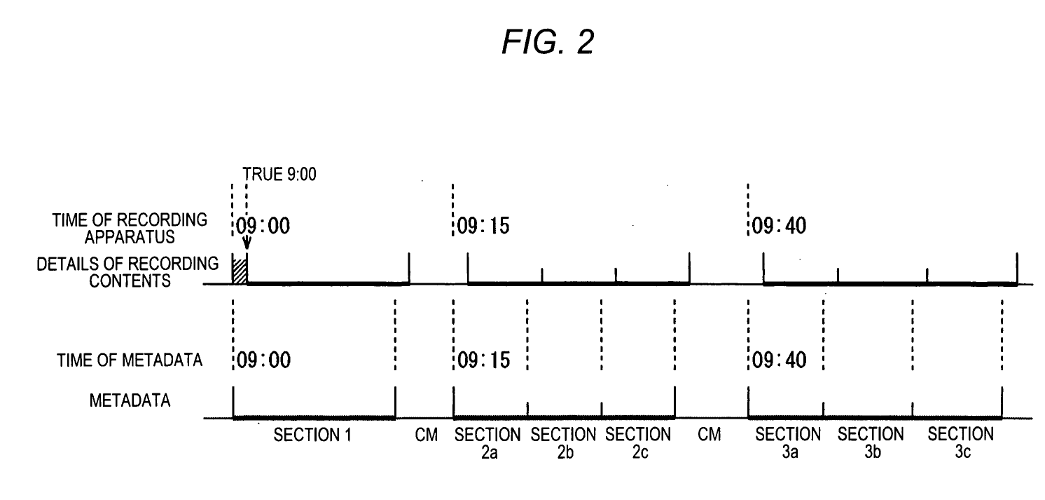

However, when the time resulting from the clock function is not accurate, as described with reference to FIG. 2, there occurs a phenomenon that the details of the contents data 51 are not matched with the details of the contents metadata 53 which is metadata corresponding thereto. In this case, for example, the intention to start the reproduction from the corner instructed by the user may cause a problem that the reproduction is started from a false position.

Therefore, the contents recording unit 24 performs the matching process to correct the difference between the time information of the contents data 51 and the time information of the contents metadata 53.

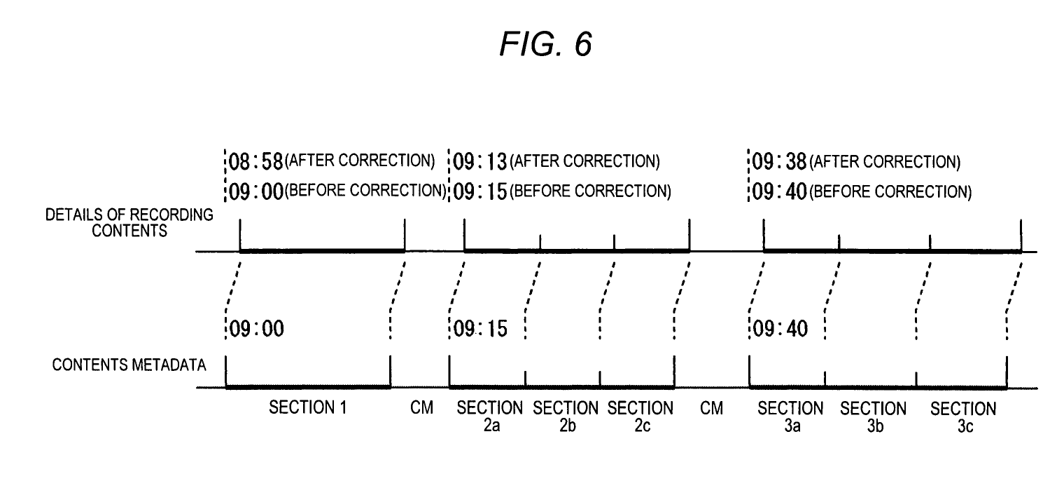

FIG. 6 is a diagram illustrating a state where the difference in time information shown in FIG. 2 is corrected by the matching process. Here, the recording start time of the file time stamp 52 is corrected to true time 8:58 from time 9:00 and time 9:00 of the head of the contents metadata 53 is correlated with the time (true time 9:00) 2 minutes ahead from the head of the contents data 51.

As a result, for example, when the contents metadata reproducing unit 62 displays information on the corners or CMs of the recording contents on the display unit 27 using the contents metadata 53 and the user instructs to pinpointly reproduce the corners or CMs of the recording contents displayed on the display unit 27, it is possible to accurately start reproducing the contents data 51 from the corner or CM instructed by the user.

In the contents metadata acquiring process shown in FIG. 5, only the newly recorded recording contents are processed, but the processes of steps S22 to S29 of FIG. 5 may be performed on the recording contents whose contents metadata 53 is acquired already, periodically or non-periodically by a predetermined number of times. This is, for example, because regarding a newly broadcast CM, a database is not prepared yet by a metadata provider and information of “no corresponding CM” is returned from the detailed information providing server 7 in the first contents metadata acquiring process, but the CM detailed information is returned in the next contents metadata acquiring process. Accordingly, by periodically or non-periodically performing the processes of steps S22 to S29 of FIG. 5 on the recording contents stored in the contents data storage unit 25, it is possible to improve the matching precision.

FIG. 7 is a block diagram illustrating a functional configuration of the contents recording unit 24 when the contents metadata acquiring process shown in FIG. 5 is performed.

The contents recording unit 24 includes a metadata acquiring section 101, a recording contents analyzing section 102, a difference calculating section 103, an evaluation value calculating section 104, and a correction section 105.

The metadata acquiring section 101 performs a process of acquiring the contents metadata 53 in steps S22 and S23 of FIG. 5. That is, the metadata acquiring section 101 transmits the detailed information providing server 7 with the file time stamp 52 of the contents data 51 not having yet the contents metadata 53 through the network 6. The metadata acquiring unit 101 receives and acquires the contents metadata 53 transmitted from the detailed information providing server 7 in accordance with the file time stamp 52 through the communication unit 23.

In this embodiment, the metadata acquiring section 101 acquires only the contents metadata 53 of the necessary recording contents from the detailed information providing server 7, but may acquire in advance the contents metadata 53 of all contents from the detailed information providing server 7 and may utilize only the necessary contents metadata 53 therefrom.

In the course of preparing the contents metadata 53 provided from the detailed information providing server 7, a stream analysis (automatic analysis) may be performed in the initial step. However, since the boundaries can be detected in the stream analysis but the details (metadata) of the corresponding sections of the program cannot be prepared, finally, the metadata is manually prepared. Accordingly, even when an error of boundaries occurs in the stream analysis, it is corrected manually. Therefore, it can be considered that the contents metadata 53 may have a difference in absolute time but a difference in relative time such as a length of a section does not occur.

The recording contents analyzing section 102 performs the contents analyzing process of steps S24 to S28 of FIG. 5. That is, the recording contents analyzing section 102 analyzes the stream of the corresponding contents data 51 and divides the program into the main sections and the CM sections. The recording contents analyzing section 102 divides the program by the plural sections when a main section is divided into plural sections corresponding to changes in details (changes in scenes) of the program, and divides the program into the single CM sections when a CM section is divided into plural single CM sections.

The boundaries of the sections are detected by extracting the feature quantities of the contents data 51. Accordingly, the recording contents analyzing section 102 may not accurately detect the main sections and the CM sections. Therefore, information of CM false detection that a section not being originally a CM section is detected as a CM section or information of CM non-detection that a section being originally a CM section is not detected as the CM section may be included in the contents data 51 after the analysis.

The difference calculating section 103 calculates a time difference candidate delta which is a candidate for time correction as a correction time for matching a boundary of a predetermined section (hereinafter, referred to as “section boundary”) of the contents data 51 of the recording contents to be corrected with a predetermined section boundary of the contents metadata 53 of the recording contents to be corrected. Plural time difference candidates delta are calculated to correspond to the number of section boundaries.

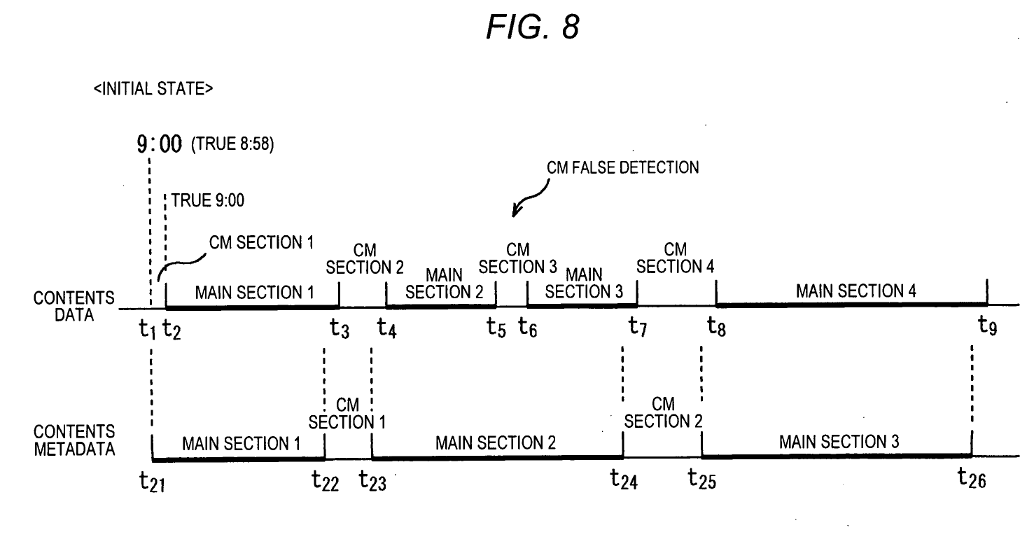

For each of the time difference candidates delta calculated by the difference calculating section 103, the evaluation calculating section 104 calculates an evaluation value PT which is a value obtained by expressing a degree of matching between the section boundaries of the contents data 51 and the contents metadata 53 as a score when all the section boundaries of the contents metadata 53 are shifted by the time difference candidates delta. The specific method of calculating the evaluation value PT will be described later with reference to FIGS. 8 to 13.

The correction section 105 determines one of the plural time difference candidates delta as the final time difference candidate Delta of the recording contents to be corrected on the basis of the evaluation values PT, corrects the time information of the contents metadata 53 of the recording contents to be corrected by the time difference candidate Delta, and stores the result in the contents data storage unit 25. The correction section 105 corrects the time information of the file time stamp 52 of the recording contents to be corrected using the time difference candidate Delta.

The evaluation value calculating process of calculating the evaluation value PT will be described in detail now with reference to FIGS. 8 to 13. An example where the matching process is performed on the section boundaries of the CM sections will be described below, but it should be understood that the same can be similarly applied to the section boundaries of sub sections when a main section is divided into plural sub sections.

FIG. 8 shows the initial states of the contents data 51 and the contents metadata 53 of the recording contents to be corrected. It is assumed as shown in FIG. 8 that the recording contents to be corrected are contents recorded from the time 9:00 resulting from the clock function of the image display device 1.

Here, the clock function of the image display device 1 leads by 2 minutes from the true time. Accordingly, the contents data 51 is recorded at 9:00 which is the true time of 8:58. In other words, time t₁ corresponds to 9:00 of the image display device 1 and the true time 8:58 and time t₂ corresponds to the true time 9:00.

Time t₁ to t₉ and time t₂₁ to t₂₆ are converted into relative time from the head time (start time) of the recording contents in advance so as to facilitate the treatment of the contents data 51 and the contents metadata 53.

According to the content analyzing process of the recording contents analyzing section 102, in the contents data 51 of the recording contents, the section between time t₁ and time t₂ is CM section 1 and the section between time t₂ and time t₃ is main section 1. The section between time t₃ and time t₄ is CM section 2 and the section between time t₄ and time t₅ is main section 2. Similarly, the section between time t₅ and time t₆ is CM section 3, the section between time t₆ and time t₇ is main section 3, the section between time t₇ and time t₈ is CM section 4, and the section between time t₈ and time t₉ is main section 4. Here, CM section 3 between time t₅ and time t₆ is a section of CM false detection of the recording contents analyzing section 102.

On the other hand, the section between time t₂₁ and time t₂₂ of the contents metadata 53 of the recording contents to be corrected and acquired from the detailed information providing server 7 is main section 1, the section between time t₂₂ and time t₂₃ is CM section 1, the section between time t₂₃ and time t₂₄ is main section 2, the section between time t₂₄ and time t₂₅ is CM section 2, and the section between time t₂₅ and time t₂₆ is main section 3.

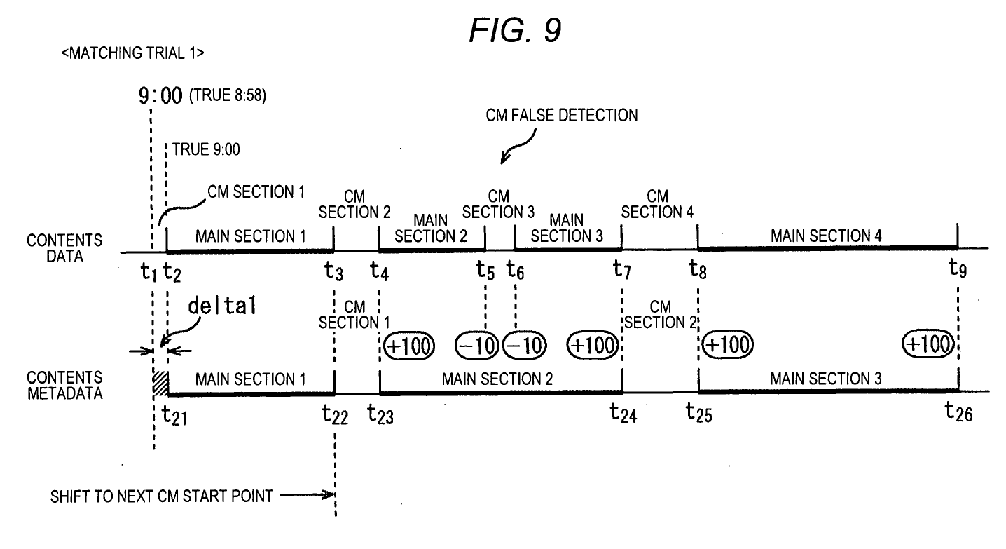

From the initial states shown in FIG. 8, the difference calculating section 103 determines a first time difference candidate delta. For example, as shown in FIG. 9, the difference calculating section 103 determines a time difference candidate delta1 as the correction time for matching time t₃ of the section boundary as the start point of CM section 2 of the contents data 51 with time t₂₂ of the section boundary as the start point of CM section 1 of the contents metadata 53. The time difference candidate delta1 is the same as the time interval from time t₁ to time t₂.

Then, the evaluation value calculating section 104 calculates the evaluation value PT1 which is the evaluation value PT of the time difference candidate delta1.

The evaluation value PT is calculated as the sum (PT=α+β+γ) of a corresponding section boundary equivalent α expressing the correspondence of the section boundaries of the CM sections of the contents data 51 to the section boundaries of the contents metadata 53 using scores, a inter-CM-section presence equivalent β expressing whether all the single CM sections of the contents data 51 are included in the CM section of the contents metadata 53 using scores, and a CM section defining equivalent γ expressing whether the single CM sections of the contents data 51 are Defined CM sections defined as a CM part using scores.

Therefore, the evaluation value PT is an addition result of weighted scores depending on whether the CM sections of the contents data 51 are included in the CM sections of the contents metadata 53 or the like.

The corresponding section boundary equivalent α, the inter-CM-section presence equivalent β, and the CM section defining equivalent γ will be described in detail now.

The corresponding section boundary equivalent α is a value obtained by adding the scores determined depending on the magnitude of a difference (absolute difference) between the section boundaries of the CM sections of the contents data 51 and the corresponding section boundaries of the contents metadata 53 on the section boundaries of all the CM sections of the contents data 51 other than the section boundaries matched by the shifting corresponding to the time difference candidate delta.

The evaluation value calculating section 104 adds “+100” when the position (time) of the section boundary of the CM section of the contents data 51 is matched with the position of the section boundary of the contents metadata 53, adds “+50” when the position of the section boundary of the contents data 51 is not matched with the position of the section boundary of the contents metadata 53 but they are in a predetermined range DS, and adds “−10” (subtracts “10”) when the position of the section boundary is not in the position range DS of the contents metadata 53 corresponding to the position of the section boundary of the contents data 51.

For example, in the example shown in FIG. 9 where the time difference candidate delta1 is applied, since time t₄ of the section boundary at the end point of CM section 2 of the contents data 51 is matched with time t₂₃ of the section boundary at the end point of CM section 1 of the contents metadata 53, the score of “+100” is added. Since time t₇ and time t₈ of the section boundaries of CM section 4 of the contents data 51 are matched with time t₂₄ and time t₂₅ of the section boundaries of CM section 2 of the contents metadata 53, the score of “+100” is added. Since time t₉ of the section boundary at the end point (the start point of CM section 5 not shown) of main section 4 of the contents data 51 is matched with time t₂₆ of the section boundary at the start point of main section 3 of the contents metadata 53, the score of “+100” is added.

On the other hand, since the CM section corresponding to time t₅ and time t₆ of the section boundaries of CM section 3 of the contents data 51 does not exist in the contents metadata 53, the score of “−10” is added.

The section where only one of the contents data 51 and the contents metadata 53 exists by shifting the time difference candidate delta1 is excluded from a calculation target for the evaluation value PT1. That is, the time interval from time t₁ to time t2 of the contents data 51 is excluded from the calculation target for the evaluation value PT1.

Accordingly, the corresponding section boundary equivalent α in the example shown in FIG. 9 is calculated as α=100−10−10+100+100+100=+380.

The inter-CM-section presence equivalent β is a value obtained by adding the scores determined depending on whether all the single CM sections of the contents data 51 are included in the CM sections of the contents metadata 53 for all the single CM sections of the contents data 51. The evaluation value calculating section 104 adds “+50” when all the single CM sections of the contents data 51 are included in the CM sections of the contents metadata 53, and adds “−50” when all the single CM sections of the contents data 51 are not included in the CM sections of the contents metadata 53.

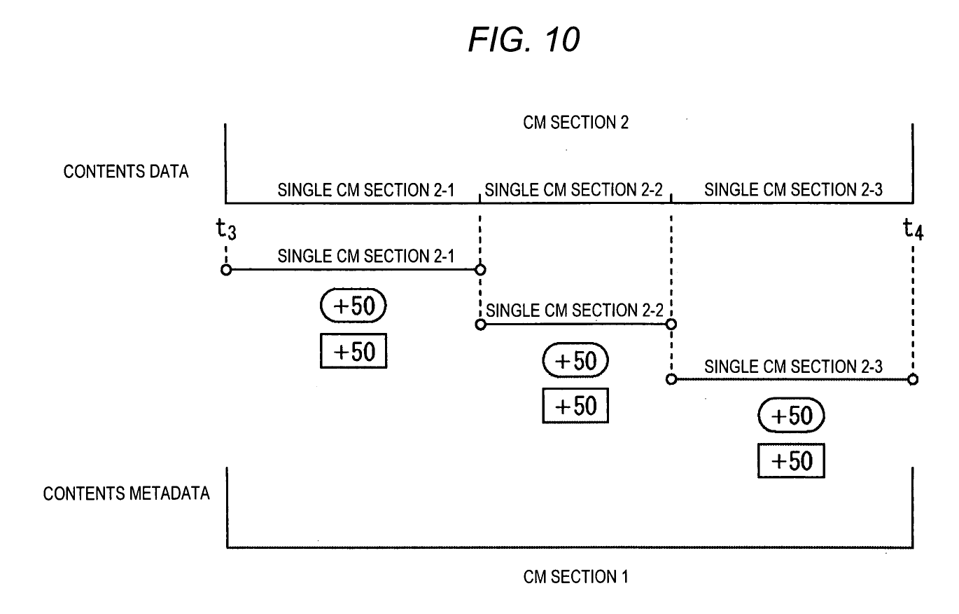

For example, FIG. 10 is an enlarged view of CM section 2 of the contents data 51 shown in FIG. 9. Here, CM section 2 of the contents data 51 includes three single CM sections 2-1 to 2-3.

In FIG. 10, since three single CM sections 2-1 to 2-3 are all included in CM section 1 of the contents metadata 53, the score of “+50” is added for the respective single CM sections 2-1 to 2-3, as indicated by the numerical value surrounded with a rounded line in the drawing.

That is, the inter-CM-section presence equivalent β in CM section 2 of the contents data 51 is calculated as β=50+50+50=+150.

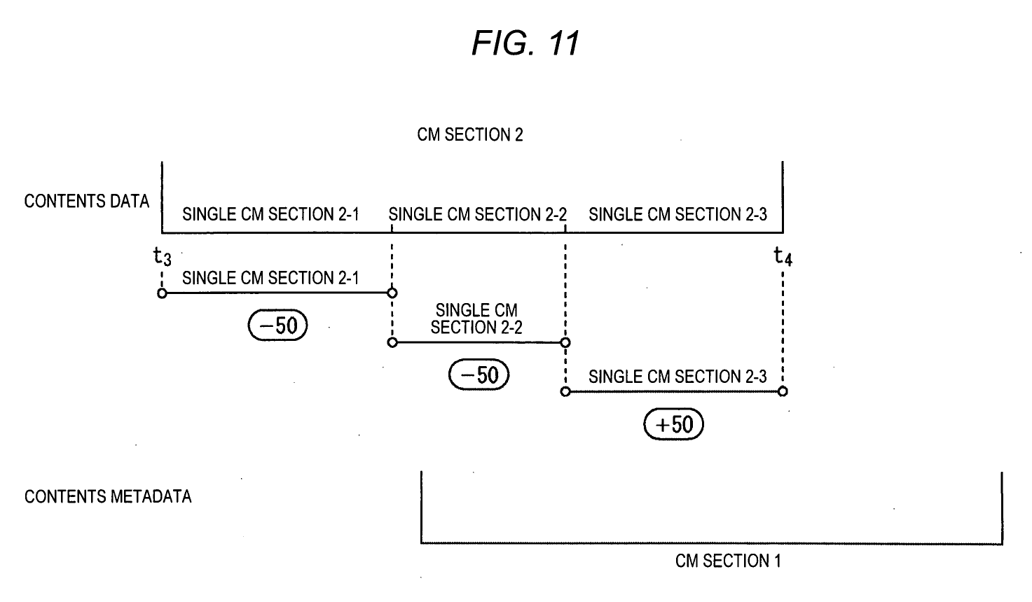

For example, when three single CM sections 2-1 to 2-3 and CM section 1 of the contents metadata 53 have the relation shown in FIG. 11, the entire single CM section 2-3 is included in CM section 1 of the contents metadata 53, but the entire single CM section 2-1 is not included in CM section 1 of the contents metadata 53 and a part of the single CM section 2-2 is included in CM section 1 of the contents metadata 53.

Accordingly, in the example shown in FIG. 11, the score of “−50” is added for the respective single CM sections 2-1 and 2-2 and the score of “+50” is added for the single CM section 2-3.

That is, the inter-CM-section presence equivalent β of CM section 2 of the contents data 51 in FIG. 11 is calculated as β=−50−50+50=−50.

The above-mentioned example is related to CM section 2 of the contents data 51, but the same calculation is performed on all the single CM sections of the contents data 51 to calculate the inter-CM-section presence equivalent β.

The CM section defining equivalent γ is a value obtained by adding scores determined depending on whether the single CM section of the contents data 51 is a defined CM section for all the single CM sections of the contents data 51. The evaluation value calculating section 104 adds a score of “+50” for the corresponding single CM section when the single CM section of the contents data 51 is a defined CM section and exits in the CM section of the contents metadata 53, and adds a score of “−1000” for the corresponding single CM section when the single CM section of the contents data 51 is a defined CM section but exists outside the CM section of the contents metadata 53. Accordingly, it is possible to exclude the time difference candidate delta when the defined CM section exists outside the CM section of the contents metadata 53. The evaluation value calculating section 104 adds a score of “+0” (does not add any score) for the corresponding single CM section when the single CM section of the contents data 51 is not a defined CM section (regardless of existing inside or outside the CM section of the contents metadata 53).

In the example shown in FIG. 10, when three single CM sections 2-1 to 2-3 are all defined CM sections, three single CM sections 2-1 to 2-3 are included as the defined CM sections in the CM section of the contents metadata 53. Accordingly, the score of “+50” is added for the respective single CM sections 2-1 to 2-3, as indicated by the numerical value surrounded with a rectangle in the drawing.

For example, since CM section 3 of the contents data 51 shown in FIG. 9 is a falsely-detected CM section and is not a Defined CM section, the score of “0” is added for CM section 3.

Accordingly, the CM section defining equivalent γ of CM section 2 and CM section 3 of the contents data 51 is calculated as γ=50+50+50+0=+150.

As described above, the evaluation value calculating section 104 calculates the corresponding section boundary equivalent α, the inter-CM-section presence equivalent β, and the CM section defining equivalent γ when the section boundaries of the contents metadata 53 are shifted by the time difference candidate delta1, and calculates the evaluation value PT1 by calculating the sum (PT=α+β+γ).

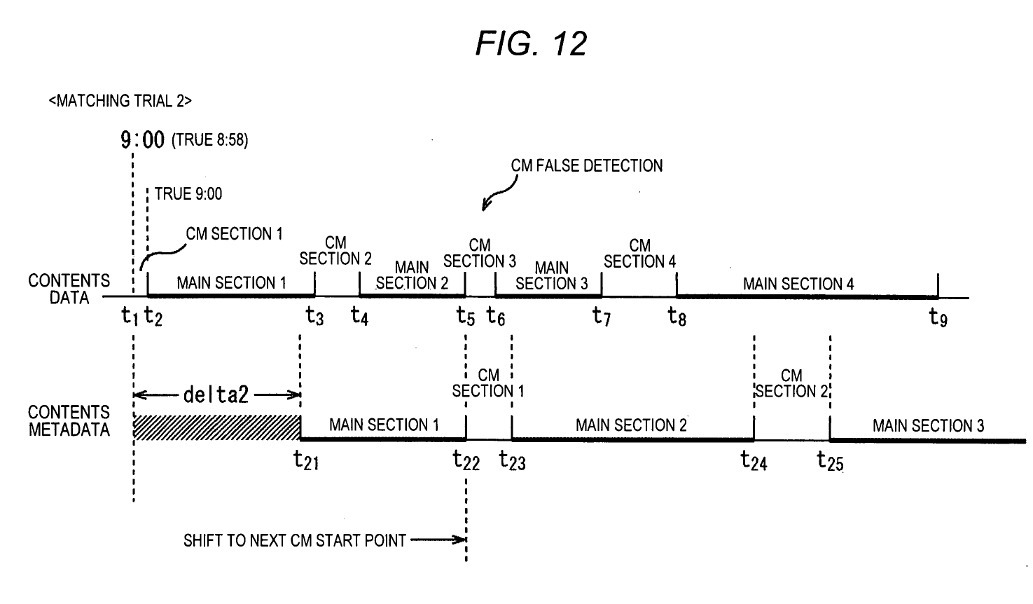

Then, as shown in FIG. 12, the evaluation value calculating section 104 determines a time difference candidate delta2 as the correction time for matching time t₅ of the section boundary as the start point of CM section 3 of the contents data 51 with time t₂₂ of the section boundary as the start point of CM section 1 of the contents metadata 53, and calculates the evaluation value PT2 of the time difference candidate delta2, similarly.

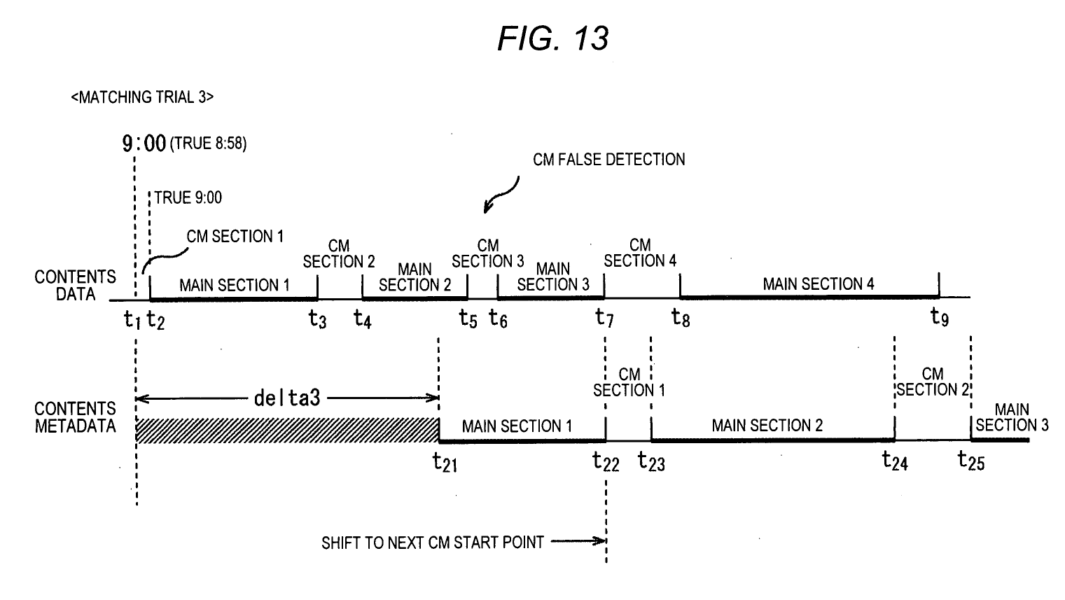

Then, as shown in FIG. 13, the evaluation value calculating section 104 determines a time difference candidate delta3 as the correction time for matching time t₇ of the section boundary as the start point of CM section 4 of the contents data 51 with time t₂₂ of the section boundary as the start point of CM section 1 of the contents metadata 53, and calculates the evaluation value PT3 of the time difference candidate delta3.

Similarly, the time difference candidate delta and the evaluation value PT are calculated for all the combinations of the start points of the CM sections of the contents data 51 and the start points of the CM sections of the contents metadata 53. The number of calculated evaluation values PT is equal to a product of (the number of CM sections of the contents data 51) and (the number of CM sections of the contents metadata 53). When the product is, for example, k, the time difference candidates delta1 to deltak and the evaluation values PT1 to PTk corresponding thereto are obtained.

The example where the evaluation value PT is calculated when the start points of the CM sections are matched with each other is described above, but the end points of the CM sections may be matched with each other. When the evaluation value PT is calculated for both the start points and the end points of the CM sections, the matching precision is improved. In this case, the number of calculated evaluation values PT is double the product of (the number of CM sections of the contents data 51) and (the number of CM sections of the contents metadata 53).

The following corresponding section boundary equivalent α′ may be employed instead of the above-mentioned corresponding section boundary equivalent α.

The corresponding section boundary equivalent a′ is a score corresponding to a standard deviation or variance (statistical value) of difference magnitudes (absolute differences) between the positions of the section boundaries of the contents data 51 and the corresponding positions of the contents metadata 53 for the section boundaries of all the CM sections of the contents data 51 other than the section boundaries matched due to the shift by the time difference candidates delta.

With the time difference candidate delta corresponding to the original correction time, since the section boundaries corresponding to the section boundaries of all the CM sections of the contents data 51 necessarily exist at the corresponding positions of the contents metadata 53, the absolute differences are a set of 0 and the statistical value is reduced. On the other hand, with the time difference candidate delta not corresponding to the original correction time, since it cannot be said that the section boundaries corresponding to the section boundaries of all the CM sections of the contents data 51 necessarily exist at the corresponding positions of the contents metadata 53 (do not exist in many cases), the statistical value is increased.

Therefore, for example, the evaluation value calculating section 104 can calculate the corresponding section boundary equivalent α′ on the basis of a table storing the scores previously classified into several steps depending on the statistical value of the absolute differences so that the corresponding section boundary equivalent α′ increases as the statistical value of the absolute differences decreases. Alternatively, a reciprocal of the statistical value of the absolute differences may be employed as the corresponding section boundary equivalent α′.

FIG. 14 is a flowchart illustrating the matching process.

First, in step S41, the difference calculating section 103 extracts CM sections of the contents data 51 of the recording contents to be corrected. The section boundaries of the extracted CM sections of the contents data 51 are converted into relative times from the head of the contents data 51.

In step S42, the difference calculating section 103 extracts CM sections of the contents metadata 53 of the recording contents to be corrected. The section boundaries of the extracted CM sections of the contents metadata 53 are converted into relative times from the recording start time.

In step S43, the difference calculating section 103 and the evaluation value calculating section 104 perform the evaluation value calculating process of calculating the evaluation values PT1 to PTk of the time difference candidates delta1 to deltak, as described with reference to FIGS. 8 to 13. The details of the evaluation value calculating process will be described later with reference to the flowchart shown in FIG. 15.

In step S44, the evaluation value calculating section 104 sets the time difference candidate delta having the highest evaluation value PT of the evaluation values PT1 to PTk as the time difference candidate Delta of the recording contents to be corrected.

In step S45, it is determined whether the evaluation value PT of the time difference candidate Delta is equal to or greater than an expected evaluation value PT₀ set in advance. When the false detection or non-detection of the CM sections often occurs in the contents analyzing process of the contents recording unit 24, it can be considered that the evaluation values PT of all the time difference candidates delta are low. Accordingly, the minimum evaluation value capable of being considered as the correct matching is determined as the expected evaluation value PT₀ depending on the number of CM sections or the length of the recording contents (recording time). This step can be omitted.

When it is determined in step S45 that the evaluation value PT of the time difference candidate Delta is equal to or greater than the expected evaluation value PT₀, the time difference candidate Delta is supplied to the correction section 105 from the evaluation value calculating section 104 and the correction section 105 applies the time difference candidate Delta to the time information (the recording start time and the recording end time) of the file time stamp 52 in step S46. For example, in the example of the recording contents shown in FIG. 8, the correction section 105 corrects the recording start time of the file time stamp 52 from 9:00 to 8:58.

In step S47, the correction section 105 corrects the time information of the contents metadata 53 by the use of the time difference candidate Delta. In the example shown in FIG. 8, since the time information of the contents metadata 53 is converted into the relative time from the head, time t₂₁ before correction is “0”, but time t₂₁ is corrected to “120 (seconds)” to correspond to the contents data 51 in which the main section is started 2 minutes after the start of the recording. The matching process is ended after the contents metadata 53 is corrected.

FIG. 15 is a flowchart illustrating the evaluation value calculating process of step S43 in FIG. 14.

First, in step S61, the difference calculating section 103 substitutes 1 for variable i recognizing the i-th CM section from the head of the contents metadata 53.

In step S62, the difference calculating section 103 determines whether variable i is smaller than (the number of CM sections of the contents metadata 53+1). When it is determined in step S62 that variable i is equal to or greater than (the number of CM sections of the contents metadata 53+1), it means that the time difference candidate delta and the evaluation value PT are calculated for all the combinations of the CM sections of the contents data 51 and the CM sections of the contents metadata 53. Accordingly, the evaluation value calculating process is ended and the matching process shown in FIG. 14 is performed again.

On the other hand, when it is determined in step S62 that variable i is smaller than (the number of CM sections of the contents metadata 53+1), the difference calculating section 103 substitutes 1 for variable j recognizing the j-th CM section from the head of the contents data 51 in step S63.

In step S64, the difference calculating section 103 determines whether variable j is smaller than (the number of CM sections of the contents data 51+1). When it is determined in step S64 that variable j is smaller than (the number of CM sections of the contents data 51+1), the difference calculating section 103 calculates the time difference candidate delta for matching CM section [i] of the contents metadata 53 with CM section [j] of the contents data 51 in step S65.

In step S66, the evaluation value calculating section 104 calculates the corresponding section boundary equivalent a, the inter-CM-section presence equivalent β, and the CM section defining equivalent γ with the time difference candidate delta calculated in step S65 and calculates the evaluation value PT by calculating the sum (PT=α+β+γ).

After the process of step S66, variable j is incremented by 1 in step S67 and then the process of step S64 is performed again.

When it is determined in step S64 that variable j is equal to or greater than (the number of CM sections of the contents data 51+1), the difference calculating section 103 increments variable i by 1 in step S68 and the process returns to step S62.

The processes of steps S62 to S68 are repeatedly performed until the time difference candidate delta and the evaluation value PT are calculated in all the combinations of the CM sections of the contents data 51 and the CM sections of the contents metadata 53. When the evaluation values PT are calculated in all the combinations, the evaluation value calculating process is ended and the process returns to the matching process of FIG. 14.

By the above-mentioned matching process, it is possible to accurately correct (adjust) the difference between the time of the contents data 51 and the time of the contents metadata 53 as shown in FIG. 6. Accordingly, for example, when the corners or CMs of the recording contents displayed on the display unit 27 using the contents metadata 53 are specified and it is instructed to reproduce the recording contents, it is possible to start reproducing the recording contents from the accurate position of the contents data 51 corresponding to the instructed reproducing start position.

In the above-mentioned example, all the evaluation values PT of the calculated time difference candidates delta are calculated (steps S65 and S66), but the time based on the clock function of the image display device 1 is hardly changed greatly. Accordingly, the maximum value (for example, 10 minutes or 30 minutes) assumed as the difference in time information may be set and the evaluation value PT may be calculated only when the calculated time difference candidate delta is equal to or less than the set maximum value. As a result, it is possible to reduce the process time of the matching process.

In the above-mentioned example, the time difference candidate delta is calculated to match the start points of the CM sections, but the same can be applied to the section boundaries of the sub sections obtained by dividing the main section into the corners. Therefore, the above-mentioned matching process can be applied to the recording contents not including the CMs. However, when no CM section is included, the inter-CM-section presence equivalent β and the CM section defining equivalent γ are not included in the calculation of the evaluation value PT.

On the other hand, the above-mentioned matching process cannot be performed, for example, on the recording contents with a short recording time including no CM and no section boundary of sub sections in the main section. In this case, the contents recording section 24 can correct the time information of recording contents (hereinafter, referred to as “unmatchable recording contents”) on which the matching process cannot be performed, by applying the time difference candidate Delta of different recording contents having the recording time close to the unmatchable recording contents.

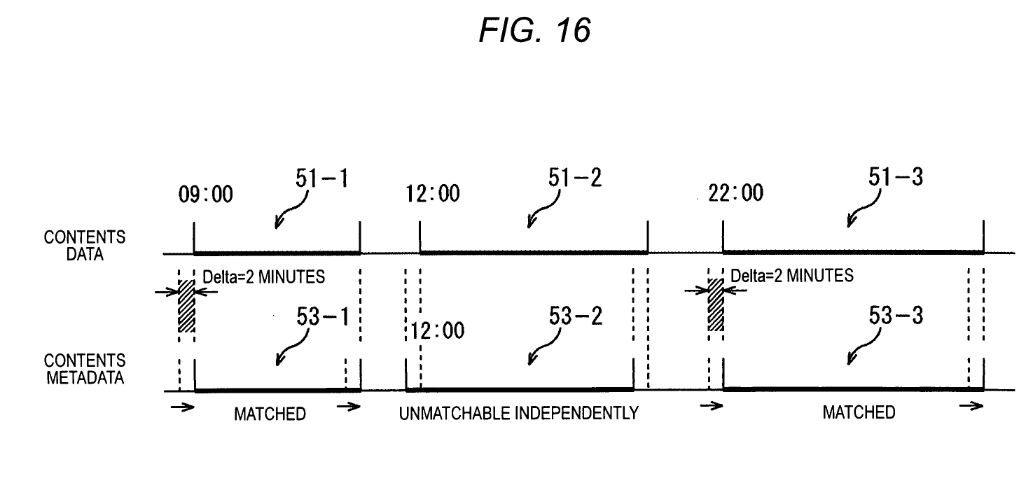

For example, as shown in FIG. 16, it is assumed that the contents data 51-1 and 51-3 of the contents data 51-1 to 51-3 are subjected to the matching process, the time difference candidates Delta are all 2 minutes, and the contents data 51-2 is the unmatchable recording contents. In this case, the contents recording unit 24 applies the difference in time information (time difference candidate Delta) of 2 minutes to the contents data 51-2 and corrects the file time stamp 52-2 of the contents data 51-2 and the contents metadata 53-2. The time difference candidate Delta of the recording contents having been subjected to the matching process is stored in the contents data storage unit 25 as needed.

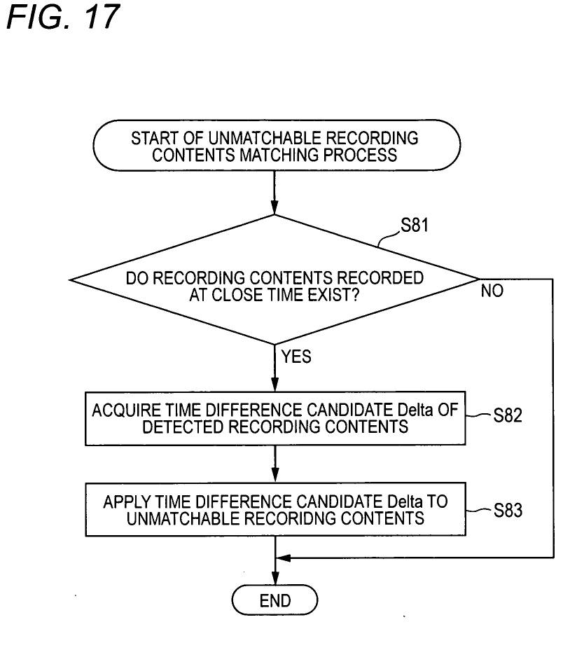

FIG. 17 is a flowchart illustrating the matching process performed on the unmatchable recording contents when the unmatchable recording contents are detected.

First, in step S81, the correction section 105 determines whether recording contents recorded at a time close to the recording time of the unmatchable recording contents exist. When it is determined in step S81 that the recording contents recorded at the time close to the recording time of the unmatchable recording contents do not exist, the matching process is ended.

On the other hand, when it is determined in step S81 that the recording contents recorded at the time close to the recording time of the unmatchable recording contents exist, in other words, when the recording contents recorded at the time close to the recording time of the unmatchable recording contents are detected, the correction section 105 acquires the time difference candidate Delta of the detected recording contents in step S82.

In step S83, the correction section 105 applies the acquired time difference candidate Delta to the unmatchable recording contents. That is, the correction section 105 performs the processes of steps S46 and S47 on the unmatchable recording contents using the acquired time difference candidate Delta and ends the process. Accordingly, it is possible to correct the time information of the unmatchable recording contents.

Another example of the matching process will be described now.

Since the matching process described with reference to FIG. 14 verifies all the combinations of the CM sections of the contents data 51 and the CM sections of the contents metadata 53, there might be a case that the execution thereof is difficult due to the restriction of the processing ability or memory capacity of the apparatus. It can be also considered that the contents metadata 53 is displayed in the state where the matching process shown in FIG. 14 cannot be ended and thus it is necessary to perform the matching process at a high speed.

Therefore, the matching process to be described below is a simple matching process of performing the matching process with ease and at a high speed to cope with that case. A condition that the difference in time information occurring in the recording contents is much smaller than the length of CM sections is required to perform the simple matching process.

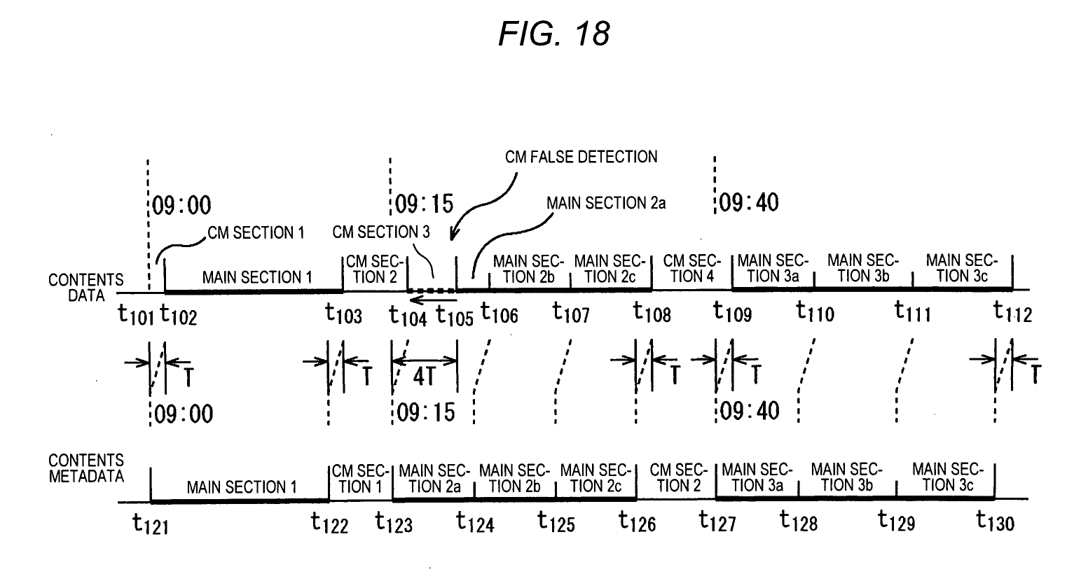

The simple matching process will be described with reference to FIG. 18.

FIG. 18 shows a state where the contents data 51 of the recording contents to be corrected is recorded using time 9:00 instead of true time 8:58, similarly to the example shown in FIG. 8. CM section 3 of the contents data 51 results from the false detection.

First, the contents recording unit 24 sets the first main section 1 from the head of the contents metadata 53 as a section of interest and acquires a start point InPoint and an end point OutPoint of the section of interest. In the example shown in FIG. 18, time t₁₂₁ is acquired as the start point InPoint and time t₁₂₂ is acquired as the end point OutPoint.

Then, the contents recording unit 24 calculates an absolute difference InDiff between the start point InPoint of the section of interest and the section boundary, where the CM section of the contents data 51 is changed to the main section, closest to the start point and calculates an absolute difference OutDiff between the end point OutPoint of the section of interest and the section boundary, where the main section of the contents data 51 is changed to the CM section, closest to the end point.

In the example shown in FIG. 18, time t₁₀₂ is detected as the section boundary, where the CM section of the contents data 51 is changed to the main section, closest to the start point InPoint of the section of interest, and time T which is the absolute difference between time t₁₂₁ and time t₁₀₂ is calculated as the absolute difference InDiff. In addition, time t₁₀₃ is detected as the section boundary, where the main section of the contents data 51 is changed to the CM section, closest to the end point OutPoint of the section of interest, and time T which is the absolute difference between time t₁₂₂ and time t₁₀₃ is calculated as the absolute difference OutDiff.

The contents recording unit 24 performs the correction using the smaller of the calculated absolute differences InDiff and OutDiff as the correction time of the section of interest. In this example, since both the absolute difference InDiff and OutDiff are time T, time T is determined as the correction time. The reason for determining the smaller of the calculated absolute differences InDiff and OutDiff as the correction time is based on the feature that the section length of the contents metadata 53 acquired from the detailed information providing server 7 is basically correct and the start point InPoint and the end point OutPoint need to have the same correction time.

The contents recording unit 24 sequentially sets main section 2 (main sections 2a+2b+2c) and main section 3 (main sections 3a+3b+3c) as the section of interest and performs the same process thereon.

When main section 2 is set as the section of interest, the absolute difference InDiff is time 4T which is four times time T due to CM section 3 falsely detected by the contents analyzing process and the absolute difference OutDiff is time T. Accordingly, time T of the smaller of the calculated absolute differences InDiff and OutDiff is determined as the correction time. When the correction time of main section 2 is time T, as can be clearly seen from FIG. 18, it is possible to exclude CM section 3 of the contents data 51 falsely detected by the contents analyzing process. The exclusion of the falsely-detected CM section by employing the smaller of the absolute differences InDiff and OutDiff is established under the condition that the difference in time information is much smaller than the length of the CM section. On the other hand, when main section 3 is set as the section of interest, the correction time is time T, similarly to the case where main section 1 is set as the section of interest.

When the main section is divided into plural sub sections like main sections 2 and 3 of FIG. 18, the section boundaries of the sub sections are corrected using the same correction time.

FIG. 19 is a flowchart illustrating the simple matching process.

First, in step S101, the difference calculating section 103 arranges the contents data 51 and the contents metadata 53 of the recording contents to be corrected in a time series. The time information of the contents data 51 and the contents metadata 53 is converted into relative time from the head.

In step S102, the difference calculating section 103 substitutes 1 for variable i for recognizing the i-th main section from the head of the contents metadata 53.

In step S103, the difference calculating section 103 determines whether variable i is smaller than (the number of main sections of the contents metadata 53+1). When it is determined in step S103 that variable i is equal to or greater than (the number of CM sections of the contents metadata 53+1), it means that the correction time for all the main sections is calculated and thus the simple matching process is ended.

On the other hand, when it is determined in step S103 that variable i is smaller than (the number of CM sections of the contents metadata 53+1), the process goes to step S104 where the difference calculating section 103 acquires the start point InPoint and the end point OutPoint of main section [i] (the i-th main section from the head of the contents metadata 53) of the contents metadata 53 as a section of interest.

In step S105, the difference calculating section 103 calculates the absolute difference InDiff between the start point InPoint of the section of interest and the section boundary (change point) of the contents data 51, where the CM section is changed to the main section, closest to the start point.

In step S106, the difference calculating section 103 calculates the absolute difference OutDiff between the end point OutPoint of the section of interest and the section boundary (change point) of the contents data 51, where the main section is changed to the CM section, closest to the end point.

In step S107, the correction section 105 determines the smaller of the calculated absolute differences InDiff and OutDiff as the correction time of the section of interest and performs the correction operation.

In step S108, the correction section 105 determines whether the main section [i] as the section of interest includes any sub section. When it is determined in step S108 that the main section does not include any sub section, the process goes to step S110.

When it is determined in step S108 that the main section includes sub sections, the correction section 105 similarly corrects the section boundaries of the sub sections in step S109 using the correction time of the main section [i] determined in step S107.

In step S110, the difference calculating section 103 increments variable i by one and then the process goes to step S103 again. The processes of steps S103 to S110 are repeatedly performed until all the main sections of the contents metadata 53 are set as the section of interest, and then the flow of processes is ended.

As described above, the simple matching process is performed in one pass by sequentially setting the main sections of the contents data 51 as the section of interest from the head thereof. In other words, in the simple matching process, since the main sections do not depend on each other, the main sections may be processed in parallel or only a predetermined range including one or more main sections of one recording contents may be processed.

In the above-mentioned simple matching process, the time information of the start point InPoint and the end point OutPoint of the CM section is corrected. However, even when no CM section exists and only plural main sections exist, the simple matching process can be applied to the section boundaries thereof. In this case, the condition that the difference in time information is much smaller than the length of the main section to be corrected must be satisfied.

The simple matching process may be performed by proper combination with the above-mentioned matching process, except when the processing ability or memory capacity of the apparatus is restricted or the matching process should be performed at a high speed.

According to the matching process and the simple matching process of the contents recording unit 24, even when the time based on the clock function of the image display device 1 is shifted from the true time, it is possible to correct (change) the time information of the contents data 51 of the recording contents and the corresponding contents metadata 53 acquired from the detailed information providing server 7 to match them with each other.

Accordingly, as described above, when the contents metadata reproducing unit 62 displays the information on the corners or CMs of the recording contents on the display unit 27 using the contents metadata 53 and the user instructs to pinpointly reproduce one corner or CM of the recording contents displayed on the display unit 27, the contents data reproducing unit 61 can reproduce the contents data 51 accurately from the corner or CM instructed by the user.

The above-mentioned series of processes may be executed by hardware or software. When the series of processes are executed by software, programs constituting the software are installed in a computer assembled into exclusive hardware or a general-purpose personal computer capable of performing various functions by installing various programs, from a program recording medium.

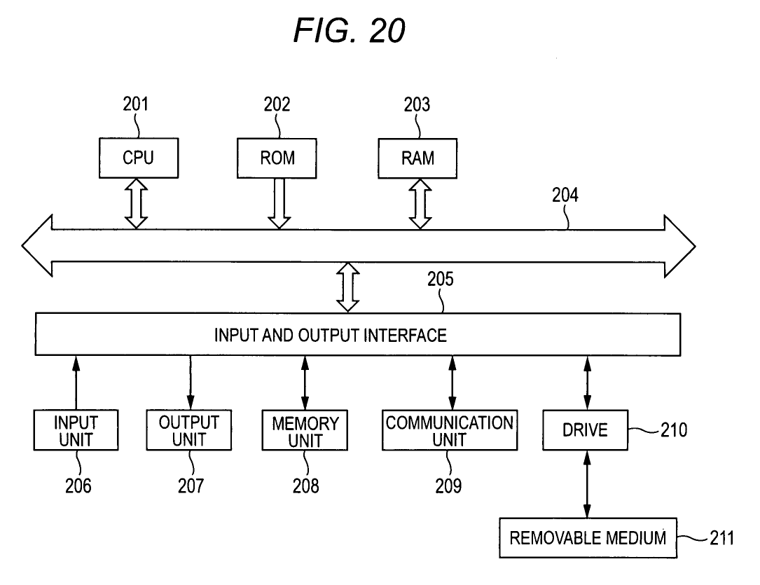

FIG. 20 is a block diagram illustrating a hardware configuration of a computer performing the above-mentioned series of processes using programs.

In the computer, a CPU (Central Processing Unit) 201, a ROM (Read Only Memory) 202, and a RAM (Random Access Memory) 203 are connected to each other through a bus 204.

An input and output interface 205 is connected to the bus 204. The input and output interface 205 is connected to an input unit 206 including a keyboard, a mouse, and a microphone, an output unit 207 including a display and a speaker, a memory unit 208 including a hard disk or a non-volatile memory, a communication unit 209 including a network interface, and a driver 210 driving a removable medium 211 such as a magnetic disk, an optical disk, a magneto-optical disk, and a semiconductor memory.

In the computer having the above-mentioned configuration, the above-mentioned series of processes are preformed by allowing the CPU 201 to load the programs stored in the memory unit 208 to the RAM 203 through the input and output interface 205 and the bus 204 and to execute the programs.

The programs executed by the computer (the CPU 201) may be recorded in the removable medium 211 which is a package medium such as a magnetic disk (including flexible disk), an optical disk (such as a CD-ROM (Compact Disc-Read Only Memory) and a DVD (Digital Versatile Disc)), a magneto-optical disk, and a semiconductor memory, or may be provided through a wired or wireless transmission medium such as a local area network, the Internet, digital satellite broadcast.

The programs can be installed in the memory unit 208 through the input and output interface 205 by mounting the removable medium 211 on the driver 210. The programs may be received by the communication unit 209 through the wired or wireless transmission medium and may be installed in the memory unit 208. Alternatively, the programs may be installed in the ROM 202 or the memory unit 208 in advance.

The programs executed by the computer may be programs for performing the flows described in the specification in a time series or may be programs for performing the processes in parallel or at a necessary time such as when they are called.

Although it has been described in the above-mentioned example that the invention is applied to the image display device, the invention can be applied to various apparatuses having a contents recording function, such as a tuner-mounted personal computer, a recording and reproducing apparatus, and a tuner-mounted mobile phone. Since the contents can be delivered through a network, the tuner is not necessarily required. The invention does not depend on whether the apparatus is of a stationary type or a portable type.

In the invention, the steps described in the flowcharts include processes performed in a time series in the described order and processes performed in parallel or individually without being necessarily performed in a time series.

The invention is not limited to the above-mentioned embodiments, but may be modified in various forms without departing from the gist of the invention.

What is claimed is:

1. An information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device comprising:
difference calculating means for calculating a time difference candidate, which is a candidate for time correction, as a correction time for matching a predetermined section boundary of the metadata with a predetermined section boundary of the contents data;
evaluation value calculating means for calculating an evaluation value indicating a degree of match of the section boundaries of the contents data and the metadata when the time information of all the section boundaries of the metadata is shifted by the time difference candidate; and
correction means for correcting the difference in time information using the time difference candidate, which has a highest evaluation value among the evaluation values calculated for the time difference candidates of all combinations in which the section boundaries of the metadata and the contents data are matched with each other, as the correction time of the time information.

2. The information processing device according to claim 1, wherein the correction means determines whether the time difference candidate having the highest evaluation value of the calculated evaluation values is equal to or greater than a predetermined expected evaluation value and corrects the difference in time information when determining that the time difference candidate is equal to or greater than the expected evaluation value.

3. The information processing device according to claim 1, wherein the evaluation value calculating means calculates the evaluation value on the basis of an absolute difference in time information between the section boundaries of the metadata and the contents data when the time information of all the section boundaries of the metadata is shifted by the time difference candidate.

4. The information processing device according to claim 3, wherein the evaluation value includes an addition result of a score corresponding to the magnitude of the absolute difference.

5. The information processing device according to claim 3, wherein the evaluation value includes a score corresponding to a statistical value of the absolute difference.

6. The information processing device according to claim 3, wherein the section boundaries include at least a section boundary for dividing the recording contents into a main section and a CM section and a section boundary for dividing the CM section into CMs.

7. The information processing device according to claim 6, wherein the correction means corrects the difference in time information using the time difference candidate, which has the highest evaluation value among the evaluation values calculated for the time difference candidates of all combinations in which the section boundaries of the metadata and the contents data are matched with each other, as the correction time of the time information, one or both of a start time and an end time of the CM section.

8. The information processing device according to claim 6, wherein the evaluation value includes an addition result of a score determined depending on whether the entire CM section of the contents data is included in the CM section of the metadata.

9. The information processing device according to claim 6, wherein the evaluation value includes an addition result of a score determined depending on whether the CM section of the contents data is a defined CM section defined as a CM part.

10. The information processing device according to claim 1, further comprising recording contents analyzing means for extracting an image feature quantity of the contents data and dividing the contents data into a plurality of sections on the basis of the extracted image feature quantity.

11. The information processing device according to claim 1, further comprising metadata acquiring means for acquiring the metadata of the recording contents from a different server.

12. The information processing device according to claim 1, wherein the correction means corrects the difference in time information of uncorrectable recording contents using the correction time of the time information of the recording contents recorded at a time close to the uncorrectable recording contents when the uncorrectable recording contents exist which are recording contents whose difference in time information cannot be corrected because the section boundaries cannot be detected.

13. An information processing method of an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing method comprising the steps of:
calculating a time difference candidate, which is a candidate for time correction, as a correction time for matching a predetermined section boundary of the metadata with a predetermined section boundary of the contents data;
calculating an evaluation value indicating a degree of match of the section boundaries of the contents data and the metadata when the time information of all the section boundaries of the metadata is shifted by the time difference candidate; and
correcting the difference in time information using the time difference candidate, which has a highest evaluation value among the evaluation values calculated for the time difference candidates of all combinations in which the section boundaries of the metadata and the contents data are matched with each other, as the correction time of the time information.

14. A program allowing a computer to perform a process of correcting a difference in time information between section boundaries of contents data of recording contents and section boundaries of metadata of the recording contents acquired independently of the contents data, where the section boundaries are boundaries of sections when the recording contents are divided into a plurality of sections, the process comprising the steps of:
calculating a time difference candidate, which is a candidate for time correction, as a correction time for matching a predetermined section boundary of the metadata with a predetermined section boundary of the contents data;
calculating an evaluation value indicating a degree of match of the section boundaries of the contents data and the metadata when the time information of all the section boundaries of the metadata is shifted by the time difference candidate; and
correcting the difference in time information using the time difference candidate, which has a highest evaluation value among the evaluation values calculated for the time difference candidates of all combinations in which the section boundaries of the metadata and the contents data are matched with each other, as the correction time of the time information.

15. An information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device comprising:
difference calculating means for acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and
correction means for correcting the difference in time information at the start point and the end point of the predetermined section of the metadata using the smaller of the first absolute difference and the second absolute difference.

16. The information processing device according to claim 15, wherein the correction means corrects start points and end points of sub sections when a predetermined section of the metadata is divided into a plurality of sub sections.

17. An information processing method of an information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing method comprising the steps of:
acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and
correcting the difference in time information at the start point and the end point of the predetermined section of the metadata using the smaller of the first absolute difference and the second absolute difference.

18. A program allowing a computer to perform a process of correcting a difference in time information between section boundaries of contents data of recording contents and section boundaries of metadata of the recording contents acquired independently of the contents data, where the section boundaries are boundaries of sections when the recording contents are divided into a plurality of sections, the process comprising the steps of:
acquiring a start point and an end point of a predetermined section of the metadata, detecting the section boundary of the contents data closest to the start point, calculating a first absolute difference which is an absolute value of a difference in time information between the detected section boundary and the start point, detecting the section boundary of the contents data closest to the end point, and calculating a second absolute difference which is an absolute value of a difference in time information between the detected section boundary and the end point; and
correcting the difference in time information at the start point and the end point of the predetermined section of the metadata using the smaller of the first absolute difference and the second absolute difference.

19. An information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device comprising:
a difference calculating unit configured to calculate a time difference candidate, which is a candidate for time correction, as a correction time for matching a predetermined section boundary of the metadata with a predetermined section boundary of the contents data;
an evaluation value calculating unit configured to calculate an evaluation value indicating a degree of match of the section boundaries of the contents data and the metadata when the time information of all the section boundaries of the metadata is shifted by the time difference candidate; and
a correction unit configured to correct the difference in time information using the time difference candidate, which has a highest evaluation value among the evaluation values calculated for the time difference candidates of all combinations in which the section boundaries of the metadata and the contents data are matched with each other, as the correction time of the time information.

20. An information processing device performing a process of correcting a difference in time information between section boundaries of contents data of recording contents and section boundaries of metadata of the recording contents acquired independently of the contents data, where the section boundaries are boundaries of sections when the recording contents are divided into a plurality of sections, the information processing device comprising:
a difference calculating unit configured to acquire a start point and an end point of a predetermined section of the metadata, detect the section boundary of the contents data closest to the start point, calculating a first absolute difference which is an absolute value of a difference in time information between the detected section boundary and the start point, detect the section boundary of the contents data closest to the end point, and calculate a second absolute difference which is an absolute value of a difference in time information between the detected section boundary and the end point; and
a correction unit configured to correct the difference in time information at the start point and the end point of the predetermined section of the metadata using the smaller of the first absolute difference and the second absolute difference.
